(19) United States
(12) Patent Application Publication
(10) Pub. No.: US 2026/0113615 A1
(43) Pub. Date: Apr. 23, 2026

(54) CLASSIFICATION AND ADVERTISEMENT OF MAKE-BEFORE-BREAK-ROAMING CAPABILITY

(71) Applicant: Cisco Technology, Inc., San Jose, CA (US)

(72) Inventors: Malcolm M. SMITH, Richardson, TX (US); Matthew A. SILVERMAN, Shaker Heights, OH (US); Brian D. HART, Sunnyvale, CA (US); Binita GUPTA, San Diego, CA (US); Indermeet S. GANDHI, San Jose, CA (US)

(21) Appl. No.: 19/280,330

(22) Filed: Jul. 25, 2025

Related U.S. Application Data
(60) Provisional application No. 63/709,191, filed on Oct. 18, 2024.

(51) Int. Cl. H04W 8/08; H04W 16/18

(52) U.S. Cl. CPC H04W 8/08; H04W 16/18

(57) ABSTRACT

The present disclosure provides techniques for classification and advertisement of MBBR capabilities in wireless networks. An AP broadcasts an advertisement that indicates one or more supported roaming modes, each roaming mode being associated with a respective RQL. The AP receives from a STA a request that includes a first roaming mode selected by the STA and one or more roaming capability parameters associated with the STA. In response to determining that the AP is capable of supporting the first roaming mode for the STA, the AP transmits to the STA a response indicating confirmation of the first roaming mode.

### CROSS-REFERENCE TO RELATED APPLICATIONS

This application claims benefit of co-pending U.S. provisional patent application Ser. No. 63/709,191 filed Oct. 18, 2024. The aforementioned related patent application is herein incorporated by reference in its entirety.

### TECHNICAL FIELD

Embodiments presented in this disclosure generally relate to wireless communication. More specifically, embodiments disclosed herein relate to classification and advertisement of make-before-break-roaming (MBBR) capabilities in wireless networks.

### BACKGROUND

Make-before-break-roaming (MBBR) is an increasingly desirable capability in Wi-Fi 8 and anticipated future Wi-Fi standards. Under the conventional break-before-make (BBM) roaming approach, a client station (STA) disconnects from the current access point (AP) before establishing a new connection with a target AP. In contrast, MBBR enables the STA to establish a link with a target AP while still maintaining its connection to the serving AP. Such an overlapping connection allows for seamless roaming between APs and therefore reduces packet loss and minimizes disruptions to latency-sensitive or high-throughput applications.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example wireless environment for MBBR capability advertisement, according to some embodiments of the present disclosure.

FIG. 2A depicts definitions of RQLs and corresponding MBBR modes, according to some embodiments of the present disclosure.

FIG. 2B depicts a cumulative signaling format for RQL-based MBBR capability advertisement, according to some embodiments of the present disclosure.

FIG. 2C depicts a bitmap signaling format for RQL-based MBBR capability advertisement, according to some embodiments of the present disclosure.

FIG. 3A depicts a numeric signaling format for advertisement of supported roaming features, according to some embodiments of the present disclosure.

FIG. 3B depicts a bitmap signaling format for advertisement of supported roaming features, according to some embodiments of the present disclosure.

FIG. 4 depicts an example interaction sequence between a STA and an AP for advertisement and negotiation of MBBR capability, according to some embodiments of the present disclosure.

FIG. 5 depicts an example method performed by a candidate AP for managing MBBR roaming interactions, according to some embodiments of the present disclosure.

FIG. 6 is a diagram depicting an example method for MBBR capability advertisement, according to some embodiments of the present disclosure.

FIG. 7 depicts an example network device configured to perform various aspects of the present disclosure, according to some aspects of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, including: broadcasting, by an access point (AP), an advertisement that indicates one or more supported roaming modes, each roaming mode being associated with a respective roaming quality level (RQL); receiving, by the AP and from a station (STA), a request that comprises a first roaming mode selected by the STA and one or more roaming capability parameters associated with the STA; determining, by the AP, whether the AP is capable of supporting the first roaming mode for the STA, based on at least one of (i) the one or more roaming capability parameters associated with the STA or (ii) one or more network conditions; and in response to determining that the AP is capable of supporting the first roaming mode for the STA, transmitting, by the AP and to the STA, a response initiating a roaming process associated with the first roaming mode.

Other embodiments in this disclosure provide one or more non-transitory computer-readable media containing, in any combination, computer program code that, when executed by operation of a computer system, performs operations in accordance with one or more of the above methods, as well as a system of a network device comprising one or more computer processors, and one or more memories collectively containing one or more programs, which, when executed by the one or more computer processors, perform operations in accordance with one or more of the above methods.

### Example Embodiments

Make-before-break-roaming (MBBR) is an increasingly desirable capability in Wi-Fi 8 (IEEE 802.11be) and anticipated future Wi-Fi standards. Unlike traditional break-before-make (BBM) roaming, where the connection to the current access point (AP) is dropped before establishing a new one, MBBR enables a station (STA) to initiate a new link with a target AP while still maintaining the existing link with the serving AP. This allows for seamless roaming between APs, reducing packet loss and disruption to latency-sensitive or high-throughput applications (e.g., voice-over-IP (VoIP), real-time gaming, and high-speed streaming).

To support MBBR, the Wi-Fi standard and various vendor-specific extensions define a range of roaming mechanisms (also referred to as MBBR modes), such as fast BSS transition, warm standby handoff (where the target AP is partially prepared), hot standby with inter-AP data forwarding, and fully redundant roaming via distributed multi-link operation (MLO) using multiple simultaneously active APs. Each of these modes represents a different balance of network burden, resource usage, and roaming quality.

However, not all APs are capable of supporting all MBBR modes, due to limitations such as backhaul bandwidth, memory allocation for traffic duplication, firmware capability, or radio hardware architecture. In addition, STAs may have hardware or power constraints that limit the feasibility of fully redundant or high-throughput roaming modes. Furthermore, STAs typically do not require knowledge of the specific roaming mechanisms supported by the AP, but are instead concerned with the resulting roaming experience or quality.

The present disclosure provides methods, systems, and apparatus for classification, advertisement, discovery, and negotiation of MBBR capabilities between APs and STAs. More specifically, an AP may advertise its supported roaming capability using a roaming quality level (RQL), which corresponds to a class of MBBR performance, such as basic Fast BSS transition (FT), warm standby, hot standby with data forwarding, or fully redundant distributed MLO. A client station (STA) may use the advertised RQL value to select a roaming mode that meets its roaming quality requirements (e.g., latency, packet loss), without interpreting the underlying roaming mechanisms.

In some embodiments, the AP may further map each RQL to the corresponding network architecture, such as seamless mobility domain (SMD) without data forwarding for warm standby, SMD with inter-AP data forwarding for hot standby, or distributed MLO for full redundancy. This association provides the STA with greater context for roaming decision-making.

In some embodiments, the AP may further signal quantitative capability information, such as the number of concurrent standby paths it can support per RQL level. Roaming may be initiated either by the STA, based on a comparison of advertised RQL values among neighboring APs, or by the network, based on its resource allocation.

In some embodiments, the AP and/or STA may advertise individual roaming-related functional features instead of using abstract RQL levels. For example, support for FT roaming, enhanced FT roaming with context transfer, SMD roaming with or without inter-AP forwarding, or distributed MLO may be signaled directly. Each feature may be described with detailed capability descriptors, including the supported data unit types (e.g., media access control (MAC) service data units (MSDUs), aggregated MSDUs (A-MSDUs), MAC protocol data units (MPDUs), aggregated MPDUs (A-MPDUs)) and applicable traffic classification (e.g., access categories (ACs), traffic identifiers (TIDs), stream class service identifiers (SCSIDs)).

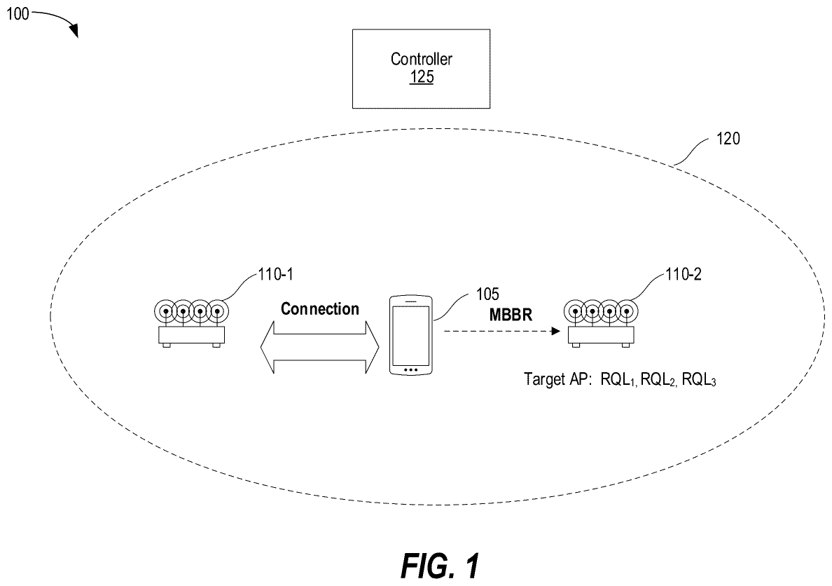

FIG. 1 depicts an example wireless environment 100 supporting MBBR capability advertisement. The wireless environment 100 includes a controller 125 and a wireless coverage area 120. The coverage area 120 may include, but is not limited to, a WLAN comprising a plurality of access points (APs) that provide wireless connectivity and mobility support to client devices. As depicted, the coverage area 120 includes at least AP 110-1 and AP 110-2, which are configured to provide network access to a client station (STA) 105 within the coverage area 120.

The STA 105 may be any wireless-capable device configured to associated with one or more APs, including, but not limited to, a smartphone, tablet, laptop, wearable device, augmented reality headset, industrial sensor, or Internet-of-Things (IoT) node. The STA 105 may be implemented as a single-link device or as a multi-link device (MLD). Similarly, the AP 110-1 and AP 110-2 may each be implemented as either single-link APs or MLD APs.

In some embodiments, the STA 105 and one or more APs 110 may support multi-link operation (MLO), in which the STA simultaneously transmits and receives across multiple frequency bands and/or multiple AP radios. The supported bands may include, for example, the 2.4 GHz, 5 GHz, and 6 GHz frequency bands. MLO may be used to increase throughput, reduce latency, and/or enable MBBR by maintaining links to both a serving and target AP during roaming.

The controller 125 may include or interface with a wireless local area network (WLAN) controller (WLC), cloud-based policy server, or enterprise mobility coordinator. The controller 125 may be configured for provisioning the WLAN and managing client onboarding and roaming within the coverage environment 120.

In the example shown in FIG. 1, STA 105 is currently connected to AP 110-1 via an active communication link. As the STA 105 moves within the coverage area 120, it approaches AP 110-2 and prepares to perform a MBBR transition. According to one embodiment disclosed herein, the target AP 110-2 may advertise its supported MBBR capabilities using a compact signaling mechanism based on RQLs. For example, AP 110-2 may support one or more RQL levels, such as RQL 1 (IEEE 802.11 k/v/r roaming with non-deterministic time-bounded due to scanning or mobility), RQL 2 (warm standby with deterministic but non-lossless handoff), and RQL 3 (hot standby with inter-AP data forwarding and near-lossless handoff). The supported RQL levels may be encoded as a cumulative capability value or as a bitmap indicating multiple supported modes. The AP 110-2 may transmit the RQL capability information via beacon frames, probe responses, or (re)association responses.

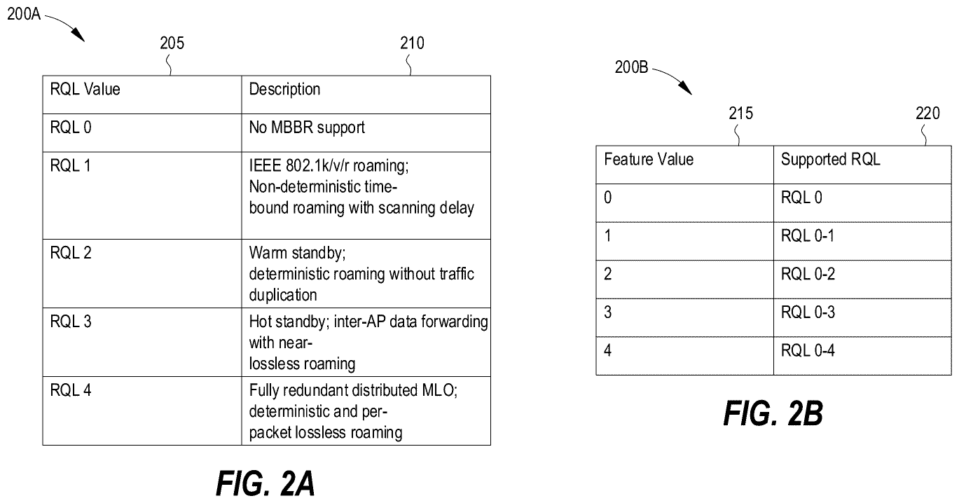

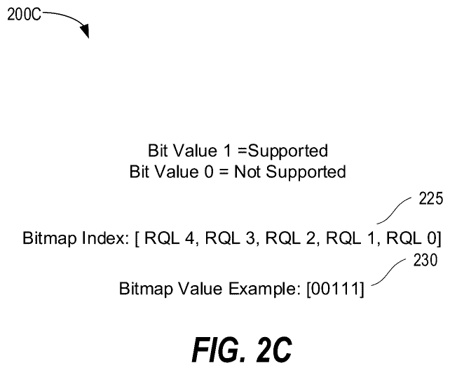

Based on the received RQL advertisements and the STA's internal roaming policy, the STA 105 may determine whether AP 110-2 supports a suitable level of MBBR quality to satisfy its application needs, without needing to interpret the underlying roaming mechanisms. The STA 105 may also indicate its own supported RQL level and its preferred RQL value during (re)association procedures. In some embodiments, controller 125 may assist in coordinating network-initiated roaming decisions based on the RQL compatibility between the STA 105 and candidate APs 110. More details regarding roaming capability advertisement, negotiation, and selection are discussed below with references to FIGS. 2-5.

FIG. 2A depicts a table 200A that includes a list of RQL values 205 and their corresponding defined roaming modes 210. The use of RQL values provides a simplified and compact way to advertise MBBR capabilities in IEEE 802.11 networks. Wi-Fi standards and vendor implementations support a variety of roaming mechanisms, including IEEE 802.11r fast BSS transition (FT), warm standby, hot standby with inter-AP forwarding, and fully redundant roaming using distributed MLO. These underlying mechanisms are different in signaling and performance characteristics. However, from a client STA's perspective, the specific MBBR mechanism used is less important than the resulting roaming behavior. More specifically, the STA (e.g., 105 of FIG. 1) may be more concerned with whether a roaming transition will meet its latency or loss tolerance requirements than how the network achieves it. The RQL abstraction allows APs (e.g., 110 of FIG. 1) to advertise roaming capability in terms of expected performance outcomes, so that STAs can make roaming decisions based on quality levels instead of implementation details.

Within this framework, 5 RQL values are defined. As depicted, RQL 0 represents a baseline case in which the AP offers no MBBR support. Roaming is performed in a traditional BBM manner, where the STA disconnects from the current AP before establishing a new link with the target AP. This mode offers no guarantee on roaming timing or data continuity and may result in service interruption.

RQL 1 corresponds to basic roaming support using mechanisms such as IEEE 802.11k (neighbor reports), 802.11v (BSS transition management), and 802.11r (fast BSS transition). The roaming latency is reduced compared to RQL 0, but still depends on factors such as scanning time and STA mobility. Packet loss may occur, the roaming quality is not guaranteed, and handoff timing remains non-deterministic.

At RQL 2, the AP supports warm standby operation, where the target AP may pre-establish partial state in anticipation of roaming. This mode allows for more predictable handover time. However, data forwarding between APs is not guaranteed, and traffic continuity may not be preserved. RQL 2 provides improved roaming responsiveness but does not guarantee lossless transition.

RQL 3 supports hot standby roaming, where inter-AP data forwarding is enabled. The STA may maintain simultaneous links with the serving and target APs, and traffic is forwarded between APs during the roaming window. The hot standby mode allows for near-lossless roaming with low disruption and is suitable for latency-sensitive applications (e.g., voice over IP (VoIP) or video conferencing).

RQL 4 is the highest quality level, where the AP supports fully redundant MBBR using distributed MLO. The STA maintains parallel active links to multiple non-collocated affiliated APs, all operating under a unified MAC SAP. Traffic duplication provides per-packet lossless roaming. The fully redundant mode offers the highest quality but also imposes the greatest resource burden on the network and AP hardware.

In some embodiments, the RQL values may be associated with specific roaming mode options defined either by the standard or by vendor profiles. For example, RQL 1 may correspond to Option A, representing IEEE 802.11k/v/r-based roaming with basic FT. Higher levels such as RQL 2 through RQL 4 may correspond to Options B, C, and D, respectively, where Option B represents warm standby, Option C represents hot standby, and Option D represents fully redundant roaming.

In some embodiments, an additional RQL value is defined between RQL 1 and RQL 2 (also referred to, for example, as RQL 1.5 or Option A.1). The additional RQL value represents enhanced roaming performance beyond basic FT. The enhanced mode improves roaming performance upon RQL 1 by reducing data loss and roaming outage time and providing some degree of data continuity through context transfer between APs. With the inclusion of the intermediate tier, the RQL framework may better differentiate networks or APs that offer upgraded FT behavior without requiring the full overhead of warm standby. As a result, the full RQL range may span from RQL 0 through RQL 5.

In some embodiments, each RQL value may further be associated with a corresponding network architecture that reflects the underlying infrastructure used to realize the roaming mode. For example, RQL 2 (Option B) may be implemented using seamless mobility domain (SMD) with no or selective inter-AP forwarding. In this architecture, the target AP may have partial knowledge of the client's state, but data forwarding is either not used or selectively applied. RQL 3 (Option C) may be implemented through SMD roaming with full inter-AP data forwarding. In this embodiment, the network architecture supports forwarding of buffered or active traffic from the serving AP to the target AP during the roaming process. RQL 4 (Option D) may be implemented using distributed MLO, where the AP presents a single MAC SAP across multiple non-collocated affiliated APs. This mode provides fully redundant roaming paths but at the cost of higher memory, backhaul, and coordination complexity. The architectural association provides the STA with greater context for roaming decision-making.

The mapping or semantic definition of each RQL value, such as its associated roaming mode (e.g., Option A-D) or underlying network architecture (e.g., SMD with forwarding, distributed MLO), may be provisioned to the AP and/or STA through either an out-of-band (OOB) or in-band mechanism. In some embodiments, OOB provisioning may occur during device configuration or firmware initialization. This allows both the AP and STA to operate with a shared understanding of how each RQL value maps to performance expectations and implementation types. In some embodiments, the mapping definitions may be shared via in-band signaling using standardized or vendor-specific information elements defined in IEEE 802.11 management frames.

Before a roaming operation occurs, each candidate AP (e.g., 110-2 of FIG. 1) may advertise its supported MBBR capability to nearby STAs. The advertisement may use either a cumulative signaling format or a bitmap signaling format.

FIG. 2B depicts an embodiment of cumulative signaling, where an AP advertises a single numeric value that indicates the highest supported RQL level. In this format, all lower RQL levels are implicitly supported. In the illustrated table 200B, the column labeled Feature Value 215 represents the cumulative numeric indicator transmitted by the AP, and the column labeled Supported RQLs 220 lists the corresponding set of RQL levels that are supported based on the advertised value. For example, a feature value of 2 indicates that the AP supports RQL 0 through RQL 2 (e.g., from basic FT to warm standby), a value of 3 indicates support for RQL 0 through RQL 3 (e.g., from basic FT to hot standby), and a value of 4 indicates support for RQL 0 through RQL 4 (e.g., up to fully redundant distributed MLO-based roaming). The STA may interpret the cumulative value upon receiving it in beacon frames, probe responses, or (re)association responses, and determine whether the AP satisfies the STA's roaming quality preference or constraint.

The compact representation reduces signaling overhead and enables efficient capability advertisement, especially in scenarios where the AP supports a full range of modes and intends to indicate upward compatibility using minimal (or at least reduced) signaling.

FIG. 2C depicts an embodiment that uses a bitmap signaling format 200C to advertise MBBR capability. In this configuration, the AP broadcasts a fixed-length bit field, where each bit position corresponds to a specific RQL level. A bit value of “1” indicates that the corresponding RQL value is supported, and a bit value of “0” indicates it is not.

As shown in FIG. 2C, a 5-bit bitmap 225 is used, with each bit mapped to a respective RQL value. The example 230 illustrated shows a value of “00111,” indicating that RQL 0, RQL 1, and RQL 2 are supported, and RQL 3 and RQL 4 are not. The bitmap signaling method provides more granular control over advertised capabilities and may be preferred in embodiments where the APs have non-continuous support across RQL levels (e.g., supporting RQL 1 and RQL 3 but not RQL 2) due to memory, throughput, or architecture constraints. The bitmap may be conveyed in management frames such as beacon or probe response elements, using vendor-specific or standardized information elements.

In some embodiments, the AP may further signal quantitative capability information to provide more detailed context for roaming decision-making. For example, the AP may indicate the number of concurrent standby paths it can support for each RQL level. This is particularly relevant in dynamic mobility scenarios where the client STA may be moving toward multiple candidate APs simultaneously, and the network may need to reserve resources for more than one potential roaming target.

Quantitative indicators may include, for example, the number of warm standby (RQL 2), hot standby (RQL 3), or fully redundant (RQL 4) handoff paths the AP can provide concurrently. For example, an AP may support up to 2 warm standby paths, 1 hot standby path, and 0 fully redundant paths at a given time. These values reflect the AP's available memory, backhaul bandwidth, radio processing limits, or current load. The quantitative information may be conveyed through extended information elements or vendor-specific signaling fields in beacon frames, probe responses, or (re)association responses. The fields may use a structured format, for example, a per-RQL capability block containing a field for the RQL level and an associated numeric value indicating the supported instance count.

In some embodiments, the AP and/or STA may advertise individual roaming-related functional features instead of using abstract RQL levels. This approach may be used when roaming behavior needs to be negotiated at a granular level or when the STA is capable of interpreting roaming mechanisms at the functional level.

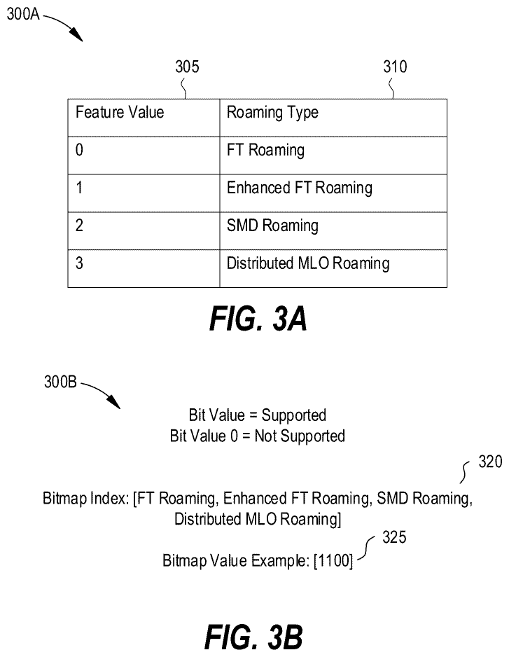

FIG. 3A depicts an embodiment in which an AP uses a non-cumulative numeric signaling format to advertise its supported roaming features (or functions). The format may use a fixed or extensible enumeration scheme where each feature value corresponds to a specific roaming type or mechanism. In the illustrated table 300A, the column labeled Feature Value 305 contains the encoded value that represents the advertised roaming function, and the column Roaming Type 310 specifies the corresponding roaming mechanism.

For example, a feature value of 0 corresponds to FT roaming, which enables Fast BSS Transition using mobility domain information and reassociation optimizations. A value of 1 represents enhanced FT roaming, which may include optimizations such as context transfer, reduced outage time, or selective data buffering. A value of 2 corresponds to SMD roaming, which involves coordinated roaming within a SMD, potentially with inter-AP forwarding. A value of 3 indicates support for distributed MLO roaming, where a multi-link station maintains simultaneous active links with multiple APs operating under a unified MAC SAP for lossless and deterministic handoff.

With the signaled feature values, the AP enables more transparent negotiation of roaming capabilities. This approach allows the STA to select or filter target APs based on specific supported mechanisms. The numeric feature values may be included within an information element or vendor-specific extension and conveyed through management frames, such as beacon frames, probe responses, or (re)association responses.

FIG. 3B depicts an embodiment where the AP advertises its roaming feature support using a bitmap format. In this approach, each bit position in the bitmap 320 corresponds to a specific roaming function. A bit value of “1” indicates that the corresponding feature is supported, and a value of “0” indicates the feature is not supported. The format allows multiple supported features to be signaled simultaneously and enables more compact representation when multiple roaming modes are available. For example, an example bitmap value of “1100” (as depicted by 325) indicates that Basic FT and enhanced FT are supported, but SMD roaming and distributed MLO are not.

In some embodiments, the functional signaling may be combined with additional signaling fields to convey granular capability information associated with each roaming type. These fields may indicate the types of data units for which inter-AP data forwarding is supported, such as whether forwarding applies to MSDUs only, MSDUs and A-MSDUs, or MPDUs and A-MPDUs. The signaling may further specify traffic classification and identify the set of ACs, TIDs, or SCSIDs for which forwarding is enabled. For example, for enhanced FT or SMD roaming, the AP may signal that it supports forwarding of MSDUs and A-MSDUs for ACs corresponding to voice and video traffic (e.g., AC_VO, AC_VI), and for specific TIDs such as 5, 6, and 7.

Although FIGS. 2A-2C and 3A-3B illustrate signaling formats used by the AP to advertise its supported MBBR capabilities, similar mechanisms may also be used by the STA to indicate its own roaming capability. Specifically, during the probe request and (re)association request phases, the STA may include corresponding information elements that convey its supported/preferred RQL levels or the set of individual roaming functions it supports or prefers. For example, in an embodiment aligned with the RQL-based signaling format (FIGS. 2A-2C), the STA may include a cumulative RQL value or bitmap in the probe request, indicating the maximum roaming quality level it supports. This allows the AP to determine whether the STA is compatible with the AP's advertised mode and select a roaming configuration that matches the STA's capability profile. For feature-level signaling (FIGS. 3A and 3B), the STA may indicate which roaming functions (e.g., basic FT, enhanced FT, SMD roaming, or distributed MLO) it supports. The signaling may also include per-feature details such as supported data forwarding types or applicable traffic classes.

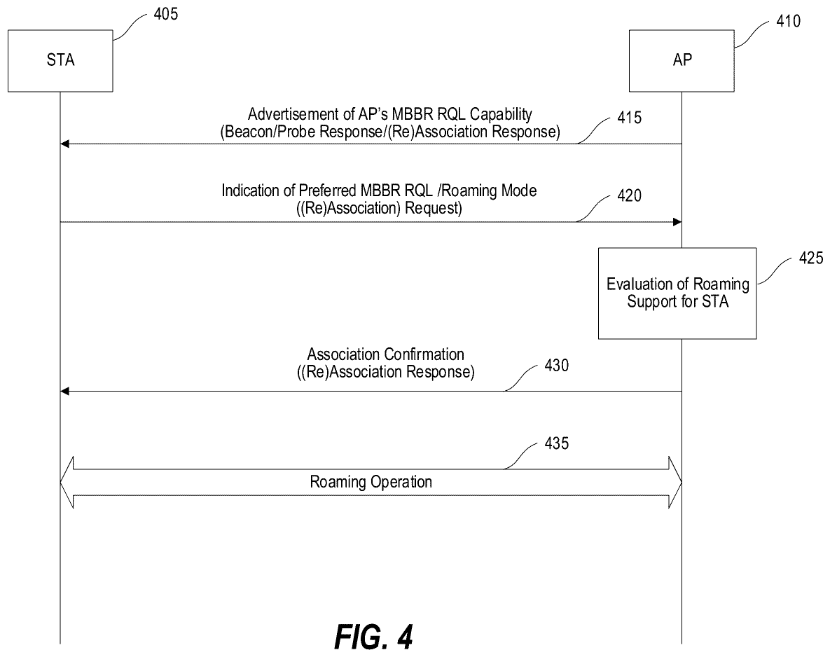

FIG. 4 depicts an example interaction sequence 400 between a STA and a candidate AP for advertisement and negotiation of MBBR capability. The STA 405 may correspond to the STA 105 depicted in FIG. 1, and the candidate AP 410 may correspond to AP 110-2 depicted in FIG. 1. The figure illustrates the signaling exchanged during roaming preparation, where the STA evaluates the AP's capability and initiates a handoff if the advertised support meets the STA's roaming requirements.

As depicted, the AP 410 first transmits its MBBR capability information to the STA (as depicted by step 415). The information may be included in a beacon frame, probe response, (re)association response, or access network query protocol (ANQP) response, depending on whether the STA is passively scanning (e.g., listening for beacons), actively probing (e.g., sending a probe request and receiving a probe response), or already engaged in a roaming procedure. The capability information may be signaled in either RQL-based format (e.g., using a cumulative or bitmap as shown in FIGS. 2B-2C) or as individual feature/function indicators (e.g., as shown in FIGS. 3A-3B). The advertisement may include a single RQL-level representation of the AP's highest supported roaming mode, or a list of supported roaming functions such as FT roaming, enhanced FT with context transfer, SMD roaming, or distributed MLO roaming.

In some embodiments, the AP may also include quantitative capability indicators, such as the number of concurrent warm standby paths (RQL 2), hot standby paths (RQL 3), or distributed MLO paths (RQL 4) that the AP is currently capable of supporting. The additional information helps the STA to evaluate whether a roaming mode is practically available under current network conditions.

Based on the received MBBR advertisement and its internal roaming policy or application-specific requirements, the STA may indicate its preferred RQL level or specific roaming function (e.g., enhanced FT or SMD roaming) (as depicted by step 420). In some embodiments, the STA 405 may also include its own MBBR capability, allowing the AP to validate mutual compatibility and select an appropriate roaming mode. The STA's preference and capability information may be conveyed in a (re)association request format or through other suitable management frame extensions. These fields may be encoded using a numeric value or bitmap.

Upon receiving the request, the AP 410 evaluates the request based on its current configuration and resource availability. The evaluation may consider the STA's preferred mode and compatibility, the AP's quantitative support limits, and overall network load or roaming policies.

In some embodiments, the selection or feasibility of a given roaming level, particularly higher RQL levels such as RQL 4 (corresponding to fully redundant roaming), may be limited by the memory and maximum throughput capabilities of both the STA and the AP. Certain client devices, even within the same vendor portfolio, may have different amounts of memory and architectural capabilities. For example, to support RQL 4 (Option D), a STA may be required to double the buffer memory used for radio traffic, as well as maintain multiple concurrent link contexts. Some high-performance STA chips may have only enough physical (PHY) memory to store calibration data for a single channel, and may lack sufficient radio firmware memory to manage redundant paths. Moreover, hitless roaming under RQL 4 may require the STA to support double its nominal throughput, since traffic may be duplicated across both the serving and target APs during the roaming.

Similar limitations may apply to APs. Although two APs may support comparable PHY data rates, they may differ in processing power, internal buffer depth, and overall system throughput. An AP with fewer computational resources may not sustain the same feature set under high-load conditions. For example, the AP may offer 30% less maximum effective throughput or reduced concurrency across roaming sessions. As a result, capability advertisement and mode selection may account for these platform-level differences. The diversity of hardware across Wi-Fi 8 portfolios reinforces the need for flexible signaling mechanisms, such as RQL levels, feature identifiers, and quantitative indicators, so that devices can discover and negotiate roaming capabilities in a manner that reflects their real-time operational limits.

If the selected RQL level or roaming feature is supported under current conditions, the AP 410 proceeds to transmit a (re)association response to the STA 405 (as depicted by step 430). The response may implicitly or explicitly confirm acceptance of the selected roaming mode or feature. For example, in some embodiments, the (re)association response may include a negotiated RQL value or feature identifier. In other embodiments, the acceptance may be implied by the successful completion of the association exchange. In either case, the response finalizes the MBBR negotiation and indicates to the STA 405 that the selected roaming mode is supported and active for the pending handoff.

Following the confirmation, the roaming operation is initiated (as depicted by step 435) using the agreed-upon mode or feature. The specific action taken depends on the selected RQL level or roaming mechanism. For example, if the selected mode corresponds to warm or hot standby (e.g., RQL 2 or RQL 3), the AP 410 may begin reserving link resources, such as buffer space or radio processing slots. For modes involving inter-AP forwarding, the AP 410 may coordinate with the serving AP to establish forwarding paths and to enable partial or full duplication of traffic during the transition window. If the selected mode is distributed MLO roaming (e.g., RQL 4), the AP 410 may initiate multi-link coordination, including synchronization of MAC contexts and setup of concurrent links across non-collocated radios under a unified MAC SAP.

In some embodiments, once the candidate AP 410 receives the STA's roaming capability parameters (e.g., its preferred/selected roaming mode, supported RQL level, or feature-level roaming support), the information may be shared with one or more APs within the same wireless network domain. Such inter-AP communication may occur through internal controller signaling, distributed control plane protocols, or vendor-specific management channels.

The disclosed embodiments herein provide adaptive and capability-aware management mechanisms that support a range of MBBR types. The defined roaming levels (also referred to in some embodiments as Option A/B/C/D) represent increasing levels of network complexity and resource burden. For example, RQL 2 (Option B) relies on basic 802.11k/v/r mechanism with non-deterministic behavior, whereas RQL 4 (Option D) may involve per-packet traffic duplication across distributed APs to achieve lossless roaming. The upper-tier modes require greater memory, throughput, and coordination across the infrastructure, and therefore may not be supported by all hardware platforms or under all operating conditions.

By enabling each device (AP or STA) to advertise or communicate its MBBR capabilities, the system provides a foundation for intelligent roaming decision-making on both ends of the link. The negotiation framework allows a roaming client to select the most feasible or desired mode (or at least a mode with improved performance) based real-time network limitations, performance requirements (e.g., for latency-sensitive applications), and compatibility with the candidate AP. Additionally, the network can allocate its roaming resource more efficiently by assessing the cost-benefit tradeoffs associated with each roaming mode in view of its current load and policy preferences.

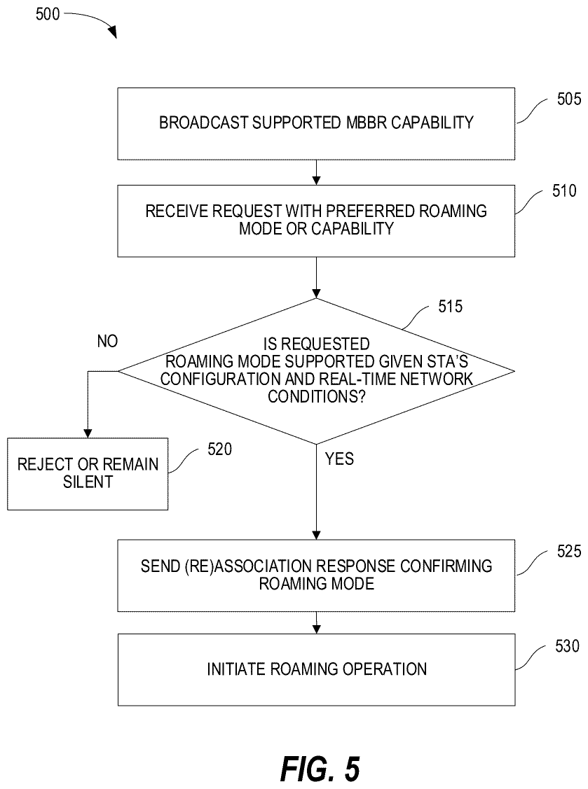

FIG. 5 depicts an example method 500 performed by an AP for managing MBBR roaming interaction in accordance with the techniques described herein. The AP performing the example method may correspond to AP 110-2 depicted in FIG. 1 or AP 410 depicted in FIG. 4.

At block 505, the AP advertises its supported MBBR roaming capabilities. The advertisement may be triggered either through passive observation of probe requests, or through active initiation of a reassociation exchange. The advertisement may be conveyed via beacon frames, probe responses, or (re)association responses. The signaling may be based on abstract RQL values (e.g., represented cumulatively or via bitmap format as illustrated in FIGS. 2B and 2C). In other embodiments, the signaling may communicate individual roaming features or modes, such as FT roaming, enhanced FT roaming, SMD roaming, or distributed MLO, as shown in FIGS. 3A and 3B. In some embodiments, the AP may additionally include quantitative capability indicators, such as the number of concurrent standby links it can support for warm, hot, or redundant roaming modes.

At block 510, the AP receives a (re)association request from the STA. The request may include the STA's preferred RQL value or specific roaming feature selection. In some embodiments, the request may further include the STA's own MBBR capability and any relevant constraints (e.g., memory or throughput limitations). The request may be encoded using any of the signaling formats discussed above with references to FIGS. 2A-2C and FIGS. 3A-3B.

At block 515, the AP evaluates whether the requested/selected roaming mode is supported based on a combination of factors, including the AP's current configuration and capabilities (e.g., memory, processing limits, firmware features), the compatibility of the requesting STA (as indicated by the STA's advertised capability or internal constraints), and the real-time network conditions (e.g., current load, available buffer space, concurrent roaming sessions, or preconfigured roaming policies). If the requested mode is supported, the method 500 proceeds to block 525, where the AP transmits an association response that confirms the requested roaming mode or RQL value. The response may explicitly indicate the agreed mode or may serve as an implicit confirmation through successful reassociation.

Following the confirmation, at block 530, the AP initiates configuration setup for the agreed-upon MBBR mode. The operations may include reserving link-layer resources, establishing inter-AP data forwarding paths, or configuring multi-link operation across distributed AP radios. These preparations enable the AP to support a seamless roaming from the serving AP to itself using the selected MBBR mode.

If the requested mode is not supported, the method 500 proceeds to block 520. In this configuration, the AP may remain silent (e.g., not respond to the association request), may transmit an explicit rejection, or may respond with a downgraded capability level (e.g., lower RQL or subset of supported features) if the signaling format allows for such negotiation.

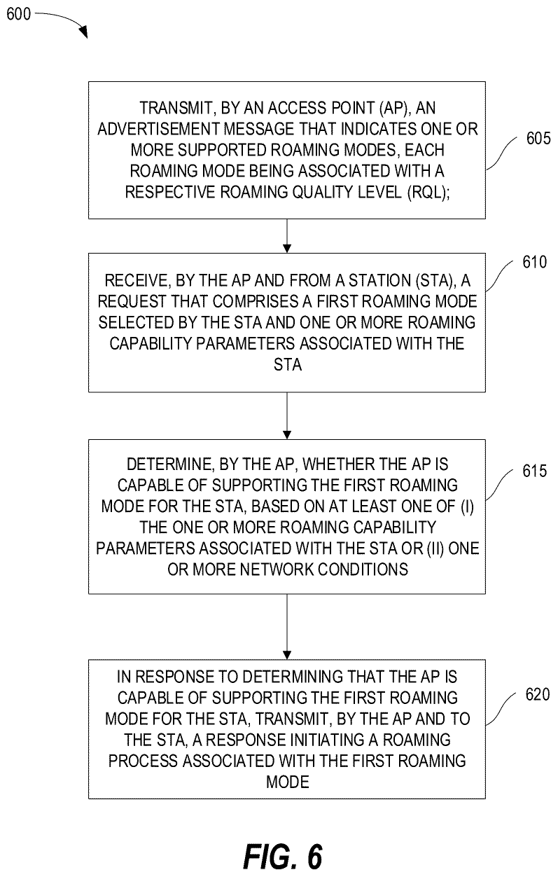

FIG. 6 is a diagram depicting an example method for MBBR capability advertisement, according to some embodiments of the present disclosure.

At block 605, an AP transmits an advertisement message that indicates one or more supported roaming modes, each roaming mode being associated with a respective roaming quality level (RQL).

At block 610, the AP receives, from a STA, a request that comprises a first roaming mode selected by the STA and one or more roaming capability parameters associated with the STA.

At block 615, the AP determines whether the AP is capable of supporting the first roaming mode for the STA, based on at least one of (i) the one or more roaming capability parameters associated with the STA or (ii) one or more network conditions.

At block 620, in response to determining that the AP is capable of supporting the first roaming mode for the STA, the AP transmits, to the STA, a response initiating a roaming process associated with the first roaming mode.

In some embodiments, the one or more supported roaming modes may comprise at least one of a first mode associated with roaming that is not time-bounded and does not guarantee roaming completion with a defined period, a second mode associated with roaming that is time-bounded in a non-deterministic manner and supports fast transition procedures, a third mode associated with roaming that is time-bounded in a deterministic manner using standby APs that are active during roaming, a fourth mode associated with roaming that is time-bounded in a deterministic manner, wherein traffic is forwarded to one or more target APs to avoid data loss during roaming, or a fifth mode associated with roaming that is time-bounded and guarantees no data loss during roaming, wherein the AP duplicates traffic across a plurality of non-collocated APs under a distributed multi-link operation architecture.

In some embodiments, the third mode may be associated with a first seamless mobility domain (SMD) infrastructure, wherein one or more candidate APs are maintained in a standby state and data forwarding between the AP and the one or more candidate AP is selectively enabled, the fourth mode may be associated with a second SMD infrastructure, wherein traffic associated with the STA is forwarded to the one or more target APs prior to completion of roaming, and the fifth mode may be associated with a third SMD infrastructure, wherein the AP and the plurality of non-collocated APs form a multi-link device that presents a unified media access control service access point (MAC SAP) to a distribution system (DS), and traffic is duplicated and forwarded to the plurality of non-collocated APs during roaming.

In some embodiments, the advertisement message may further comprise one or more roaming types supported by the AP, the one or more roaming types comprising at least one of fast basic service set (BSS) transition (FT) roaming, enhanced FT roaming with support for inter-AP context transfer, seamless mobility domain (SMD) roaming, or distributed multi-link operation (MLO) roaming.

In some embodiments, each roaming type may be advertised as being supported for one or more traffic categories.

In some embodiments, each roaming mode may be advertised as being supported for one or more traffic categories.

In some embodiments, each traffic category may be identified by at least one of a media access control service data unit (MSDU) type, an access category (AC), a traffic identifier (TID), or a stream classification service identifier (SCSID).

In some embodiments, the advertisement message may further comprise, for at least one of the supported roaming modes, a number of links that the AP is capable of concurrently supporting using the respective roaming mode.

In some embodiments, the AP may receive a query from the STA, the query requesting at least one of roaming capability information of the AP or the supported roaming modes of the AP.

In some embodiments, the AP may transmit the one or more roaming capability parameters associated with the STA to one or more neighboring APs.

In some embodiments, the advertisement message may indicate the one or more supported roaming modes using a bitmap, each bit corresponding to a respective roaming mode, a first bit value indicating that the AP supports the corresponding roaming mode, and a second bit value indicating that the AP does not support the corresponding roaming mode.

In some embodiments, the advertisement message may indicate the one or more supported roaming modes using one or more cumulative capability values, each cumulative capability value corresponding to a respective roaming mode and indicating that the AP supports the corresponding roaming mode and one or more other roaming modes with a RQL lower than the corresponding roaming mode.

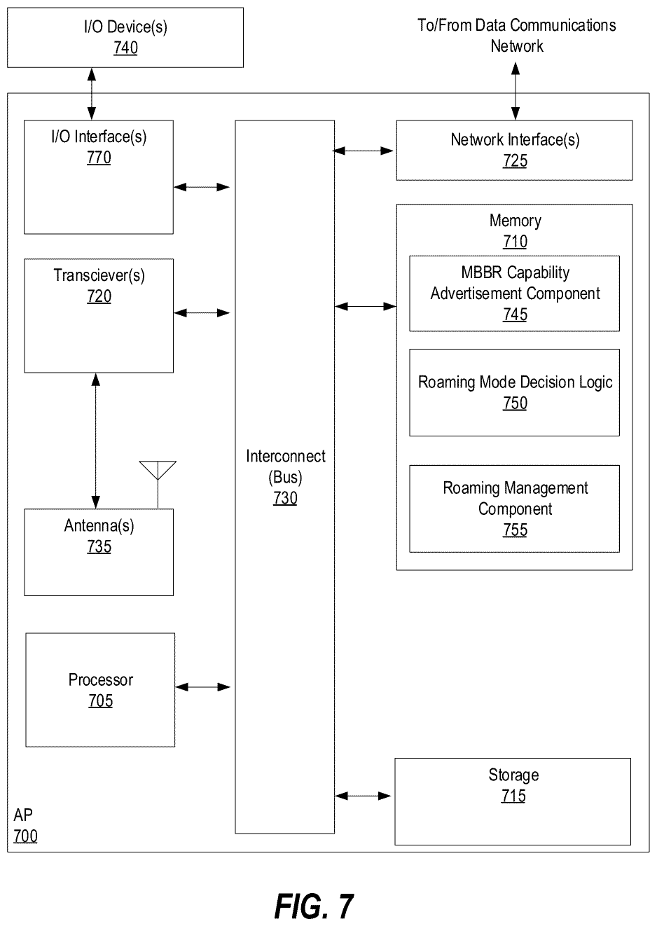

FIG. 7 depicts an example network device 700 configured to perform various aspects of the present disclosure, according to some aspects of the present disclosure.

The example network device 700 may correspond to the APs 110 as depicted in FIG. 1, AP 410 as depicted in FIG. 4, or any other network devices participating in or managing MAPC procedures (e.g., an AP of a multi-link device (MLD), a wireless controller, a router, a gateway device, a logical radio within a virtualized AP platform, or a cloud-based server).

As illustrated, the network device 700 includes a processor 705, memory 710, storage 715, one or more transceivers 720, one or more I/O interfaces 780, and one or more network interfaces 725. In some embodiments, I/O devices 770 are connected via the I/O interface(s) 780. Further, via the network interface 725, the network device 700 can be communicatively coupled with one or more other devices and components (e.g., via a network, which may include the Internet, local network(s), and the like). Each of the components is communicatively coupled by one or more buses 730. In some embodiments, one or more antennas 735 may be coupled to the transceivers 720 for transmitting and receiving wireless signals.

The processor 705 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 705 processes information received through the transceiver 720, I/O interfaces 780, and the network interfaces 725. The processor 705 retrieves and executes programming instructions stored in memory 710, as well as stores and retrieves application data residing in storage 715.

The storage 715 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 715 may store a variety of data for the efficient functioning of the system.

The memory 710 may include random access memory (RAM) and read-only memory (ROM). The memory 710 may store processor-executable software code containing instructions that, when executed by the processor 705, enable the network device 700 to perform various functions described herein for wireless communication. The memory 710 includes a MBBR capability advertisement component 745, a roaming mode decision logic 750, and a roaming management component 755.

In one embodiment, the MBBR capability advertisement component 745 is configured to encode and broadcast the AP's supported MBBR modes. The MBBR capability advertisement component 745 may generate RQL-based signaling (e.g., cumulative or bitmap formats) or feature-level signaling (e.g., individual roaming functions).

In one embodiment, the roaming mode decision logic 750 is configured to evaluate requested roaming modes based on the AP's current configuration, STA compatibility, and real-time network conditions (e.g., memory or bandwidth usage, link utilization). The roaming mode decision logic 750 determines whether to accept, reject, or downgrade a roaming request.

Upon acceptance of a roaming mode, in one embodiment, the roaming management component 755 provisions internal resources to support the transition. The roaming management component 755 may establish inter-AP forwarding paths, reserve buffer space, or coordinate distributed MLO setup.

Although depicted as a discrete component for conceptual clarity, in some embodiments, the operations of the depicted components (and others not illustrated) may be combined or distributed across any number of components. Further, although depicted as software residing in memory 710, in some aspects, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
transmitting, by an access point (AP), an advertisement message that indicates one or more supported roaming modes, each roaming mode being associated with a respective roaming quality level (RQL);
receiving, by the AP and from a station (STA), a request that comprises a first roaming mode selected by the STA and one or more roaming capability parameters associated with the STA;
determining, by the AP, whether the AP is capable of supporting the first roaming mode for the STA, based on at least one if (i) the one or more roaming capability parameters associated with the STA or (ii) one or more network conditions; and
in response to determining that the AP is capable of supporting the first roaming mode for the STA, transmitting, by the AP and to the STA, a response initiating a roaming process associated with the first roaming mode.

2. The method of claim 1, wherein the one or more supported roaming modes comprise at least one of:
a first mode associated with roaming that is not time-bounded and does not guarantee roaming completion with a defined period;
a second mode associated with roaming that is time-bounded in a non-deterministic manner and supports fast transition procedures;
a third mode associated with roaming that is time-bounded in a deterministic manner using standby APs that are active during roaming;
a fourth mode associated with roaming that is time-bounded in a deterministic manner, wherein traffic is forwarded to one or more target APs to avoid data loss during roaming; or
a fifth mode associated with roaming that is time-bounded and guarantees no data loss during roaming, wherein the AP duplicates traffic across a plurality of non-collocated APs under a distributed multi-link operation architecture.

3. The method of claim 2, wherein:
the third mode is associated with a first seamless mobility domain (SMD) infrastructure, wherein one or more candidate APs are maintained in a standby state and data forwarding between the AP and the one or more candidate AP is selectively enabled;
the fourth mode is associated with a second SMD infrastructure, wherein traffic associated with the STA is forwarded to the one or more target APs prior to completion of roaming; and
the fifth mode is associated with a third SMD infrastructure, wherein the AP and the plurality of non-collocated APs form a multi-link device that presents a unified media access control service access point (MAC SAP) to a distribution system (DS), and traffic is duplicated and forwarded to the plurality of non-collocated APs during roaming.

4. The method of claim 1, wherein the advertisement message further comprises one or more roaming types supported by the AP, the one or more roaming types comprising at least one of:
fast basic service set (BSS) transition (FT) roaming,
enhanced FT roaming with support for inter-AP context transfer,
seamless mobility domain (SMD) roaming, or
distributed multi-link operation (MLO) roaming.

5. The method of claim 4, wherein each roaming type is advertised as being supported for one or more traffic categories.

6. The method of claim 1, wherein each roaming mode is advertised as being supported for one or more traffic categories.

7. The method of claim 6, wherein each traffic category is identified by at least one of:
a media access control service data unit (MSDU) type,
an access category (AC),
a traffic identifier (TID), or
a stream classification service identifier (SCSID).

8. The method of claim 2, wherein the advertisement message further comprises, for at least one of the supported roaming modes, a number of links that the AP is capable of concurrently supporting using the respective roaming mode.

9. The method of claim 1, further comprising:
receiving, by the AP, a query from the STA, the query requesting at least one of roaming capability information of the AP or the supported roaming modes by the AP.

10. The method of claim 1, further comprising:
transmitting, by the AP, the one or more roaming capability parameters associated with the STA to one or more neighboring APs.

11. The method of claim 1, wherein the advertisement message indicates the one or more supported roaming modes using a bitmap, each bit corresponding to a respective roaming mode, a first bit value indicating that the AP supports the corresponding roaming mode, and a second bit value indicating that the AP does not support the corresponding roaming mode.

12. The method of claim 1, wherein the advertisement message indicates the one or more supported roaming modes using one or more cumulative capability values, each cumulative capability value corresponding to a respective roaming mode and indicating that the AP supports the corresponding roaming mode and one or more other roaming modes with a RQL lower than the corresponding roaming mode.

13. A system of an access point (AP), comprising:
one or more memories collectively containing one or more programs; and
one or more processors, wherein the one or more processors are configured to, individually or collectively, perform an operation comprising:
transmitting, by an access point (AP), an advertisement message that indicates one or more supported roaming modes, each roaming mode being associated with a respective roaming quality level (RQL);
receiving, by the AP and from a station (STA), a request that comprises a first roaming mode selected by the STA and one or more roaming capability parameters associated with the STA;
determining, by the AP, whether the AP is capable of supporting the first roaming mode for the STA, based on at least one of (i) the one or more roaming capability parameters associated with the STA or (ii) one or more network conditions; and
in response to determining that the AP is capable of supporting the first roaming mode for the STA, transmitting, by the AP and to the STA, a response initiating a roaming process associated with the first roaming mode.

14. The system of claim 13, wherein the one or more supported roaming modes comprise at least one of:
a first mode associated with roaming that is not time-bounded and does not guarantee roaming completion with a defined period;
a second mode associated with roaming that is time-bounded in a non-deterministic manner and supports fast transition procedures;
a third mode associated with roaming that is time-bounded in a deterministic manner using standby APs that are active during roaming;
a fourth mode associated with roaming that is time-bounded in a deterministic manner, wherein traffic is forwarded to one or more target APs to avoid data loss during roaming; or
a fifth mode associated with roaming that is time-bounded and guarantees no data loss during roaming, wherein the AP duplicates traffic across a plurality of non-collocated APs under a distributed multi-link operation architecture.

15. The system of claim 14, wherein:
the third mode is associated with a first seamless mobility domain (SMD) infrastructure, wherein one or more candidate APs are maintained in a standby state and data forwarding between the AP and the one or more candidate AP is selectively enabled;
the fourth mode is associated with a second SMD infrastructure, wherein traffic associated with the STA is forwarded to the one or more target APs prior to completion of roaming; and
the fifth mode is associated with a third SMD infrastructure, wherein the AP and the plurality of non-collocated APs form a multi-link device that presents a unified media access control service access point (MAC SAP) to a distribution system (DS), and traffic is duplicated and forwarded to the plurality of non-collocated APs during roaming.

16. The system of claim 13, wherein the advertisement message further comprises one or more roaming types supported by the AP, the one or more roaming types comprising at least one of:
fast basic service set (BSS) transition (FT) roaming,
enhanced FT roaming with support for inter-AP context transfer,
seamless mobility domain (SMD) roaming, or
distributed multi-link operation (MLO) roaming.

17. The system of claim 13, wherein the operation further comprises:
receiving, by the AP, a query from the STA, the query requesting at least one of roaming capability information of the AP or the supported roaming modes by the AP.

18. The system of claim 13, wherein the operation further comprises:
transmitting, by the AP, the one or more roaming capability parameters associated with the STA to one or more neighboring APs.

19. The system of claim 13, wherein the advertisement message indicates the one or more supported roaming modes using a bitmap, each bit corresponding to a respective roaming mode, a first bit value indicating that the AP supports the corresponding roaming mode, and a second bit value indicating that the AP does not support the corresponding roaming mode.

20. One or more non-transitory computer-readable storage media containing, in any combination, computer program code that, when executable by a computer system, perform an operation comprising:
transmitting, by an access point (AP), an advertisement message that indicates one or more supported roaming modes, each roaming mode being associated with a respective roaming quality level (RQL);
receiving, by the AP and from a station (STA), a request that comprises a first roaming mode selected by the STA and one or more roaming capability parameters associated with the STA;
determining, by the AP, whether the AP is capable of supporting the first roaming mode for the STA, based on at least one of (i) the one or more roaming capability parameters associated with the STA or (ii) one or more network conditions; and
in response to determining that the AP is capable of supporting the first roaming mode for the STA, transmitting, by the AP and to the STA, a response initiating a roaming process associated with the first roaming mode.
